(19) United States
(12) Patent Application Publication
(10) Pub. No.: US 2026/0341839 A1
(43) Pub. Date: Oct. 29, 2026

(54) THERMAL EXCHANGE MODULE INTERFACE INCLUDING THERMALLY SHRINKABLE MATERIAL

(71) Applicant: Ford Global Technologies, LLC, Dearborn, MI (US)

(72) Inventors: Philip Michael Gonzales, Dearborn, MI (US); Seth W. Diehl, Brownstown Charter Township, MI (US); Kent Sexton, Taylor, MI (US)

(21) Appl. No.: 19/190,880

(22) Filed: Apr. 28, 2025

(51) Int. Cl. H01M 10/656; B60L 50/64; F16L 13/00; H01M 10/613; H01M 10/625; H01M 10/647; H01M 50/209

(52) U.S. Cl. CPC H01M 10/656; B60L 50/64; F16L 13/004; H01M 10/613; H01M 10/625; H01M 10/647; H01M 50/209; H01M 2220/20

(57) ABSTRACT

A system for a motor vehicle may include a thermal exchange module configured to transfer heat between a component of the motor vehicle and a fluid. The thermal exchange module is fluidly coupled to a fluid channel via an interface including a thermally shrinkable material. A method is also disclosed.

### TECHNICAL FIELD

This disclosure relates generally to battery packs for electrified vehicles, and in particular relates to thermal exchange modules, and interfaces therefor. In this disclosure, the interface includes a thermally shrinkable material.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on an internal combustion engine to propel the vehicle.

A high voltage battery pack typically powers the electric machines and other electrical loads of the electrified vehicle. The battery pack includes a plurality of battery cells and various other battery internal components that support electric propulsion of electrified vehicles.

The battery cells generate heat during charging and discharging operations. Thermal exchange plates, sometimes referred to as “cold plates,” are often employed to dissipate the heat generated by the battery cells.

### SUMMARY

In some aspects, the techniques described herein relate to a system for a motor vehicle, including: a thermal exchange module configured to transfer heat between a component of a motor vehicle and a fluid, wherein the thermal exchange module is fluidly coupled to a fluid channel via an interface including a thermally shrinkable material.

In some aspects, the techniques described herein relate to a system, wherein: the interface includes a first port and a second port at least partially within the first port, and the first port is made of a thermally shrinkable material.

In some aspects, the techniques described herein relate to a system, wherein the fluid channel includes the second port and the thermal exchange module includes the first port.

In some aspects, the techniques described herein relate to a system, wherein the fluid channel includes the first port and the thermal exchange module includes the second port.

In some aspects, the techniques described herein relate to a system, wherein: the thermal exchange module includes an inlet port, an outlet port, and a main body portion, and the main body portion includes an internal passageway fluidly coupling the inlet port to the outlet port.

In some aspects, the techniques described herein relate to a system, wherein an entirety of the thermal exchange module is made of thermally shrinkable material.

In some aspects, the techniques described herein relate to a system, wherein the inlet and outlet ports include thermally shrinkable material, and the main body portion is made of a material other than thermally shrinkable material.

In some aspects, the techniques described herein relate to a system, wherein: the inlet port is configured to receive a flow of the fluid a via the inlet port, the inlet port is fluidly coupled to the fluid channel via a first interface including a thermally shrinkable material, the outlet port is configured to expel a flow of the fluid to the fluid channel, and the outlet port is fluidly coupled to the fluid channel via a second interface including a thermally shrinkable material.

In some aspects, the techniques described herein relate to a system, wherein: the thermal exchange module is a first thermal exchange module of a plurality of thermal exchange modules of the system, the fluid channel includes a manifold configured to distribute fluid relative to each of the plurality of thermal exchange modules, and interfaces between each of the thermal exchange modules and the manifold include a thermally shrinkable material.

In some aspects, the techniques described herein relate to a system, wherein the thermally shrinkable material is a polyolefin material.

In some aspects, the techniques described herein relate to a system, wherein an entirety of the thermal exchange module is made of polyolefin.

In some aspects, the techniques described herein relate to a system, wherein: the motor vehicle is an electrified vehicle, and the thermal exchange module is arranged between battery cells within a battery array of the electrified vehicle.

In some aspects, the techniques described herein relate to a system, wherein the thermal exchange module is one of a tube, fin, or channel.

In some aspects, the techniques described herein relate to a system, wherein the component of the motor vehicle is a battery pack.

In some aspects, the techniques described herein relate to a system, wherein the interface includes an adhesive.

In some aspects, the techniques described herein relate to a method, including: establishing a fluid-tight connection between a fluid channel and a thermal exchange module of a motor vehicle by applying heat to an interface of the fluid channel and the thermal exchange module, wherein the interface includes a thermally shrinkable material.

In some aspects, the techniques described herein relate to a method, wherein: the interface includes a first port and a second port at least partially within the first port, and the first port is made of a thermally shrinkable material.

In some aspects, the techniques described herein relate to a method, wherein the fluid channel includes one of the first port or the second port, and the thermal exchange module includes the other of the first port or the second port.

In some aspects, the techniques described herein relate to a method, wherein: the thermal exchange module includes an inlet port, an outlet port, and a main body portion, the main body portion includes an internal passageway fluidly coupling the inlet port to the outlet port, and the method includes establishing a fluid-tight connection between the fluid channel and the inlet port by applying heat to a thermally shrinkable material, and further includes establishing a fluid-tight connection between the fluid channel and the outlet port by applying heat to a thermally shrinkable material.

In some aspects, the techniques described herein relate to a method, wherein: the thermal exchange module is a first thermal exchange module of a plurality of thermal exchange modules, the fluid channel includes a manifold configured to distribute fluid relative to each of the plurality of thermal exchange modules, the method includes establishing fluid-tight connections between the manifold and each of the thermal exchange modules by applying heat to interfaces between each of the thermal exchange modules and the manifold, and each of the interfaces includes a thermally shrinkable material.

### BRIEF DESCRIPTION OF THE DRAWINGS

FIG. 1 schematically illustrates an example powertrain of an electrified vehicle.

FIG. 2 is a perspective view of an example battery pack.

FIG. 3 illustrates an example arrangement of a fluid channel relative to two thermal exchange modules.

FIG. 4 schematically illustrates an example arrangement of the fluid channel relative to a thermal exchange module.

FIG. 5A illustrates an example interface between the thermal exchange module and the fluid channel before heat is applied to the interface.

FIG. 5B illustrates the interface of FIG. 5A after heat is applied to the interface.

### DETAILED DESCRIPTION

This disclosure relates generally to battery packs for electrified vehicles, and in particular relates to thermal exchange modules, and interfaces therefor. In this disclosure, the interface includes a thermally shrinkable material. Among other benefits, which will be appreciated from the below description, this disclosure establishes a robust fluid connection between a fluid channel and a thermal exchange module.

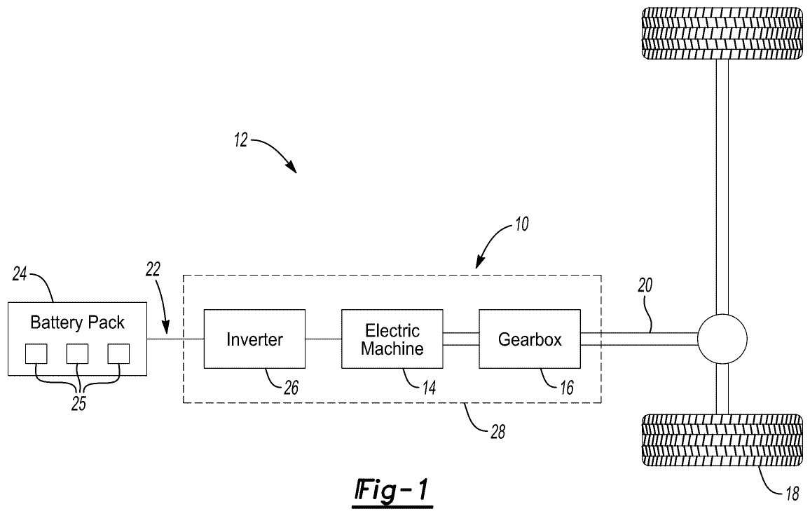

FIG. 1 schematically illustrates a powertrain 10 of an electrified vehicle 12. Although depicted as a battery electric vehicle (BEV), it should be understood that the concepts described herein are not limited to BEVs and could extend to other electrified vehicles, including but not limited to, plug-in hybrid electric vehicles (PHEVs). Therefore, although not shown in this embodiment, the electrified vehicle 12 could be equipped with an internal combustion engine that can be employed in combination with other energy sources to propel the electrified vehicle 12. Further, aspects of this disclosure could apply to vehicles that are not electrified vehicles, such as vehicles that are propelled solely by an internal combustion engine. As one example, the thermal exchange module of this disclosure could be arranged between stack plates of a fuel cell.

In a non-limiting embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The powertrain 10 shown in FIG. 1 is highly schematic and is not intended to limit this disclosure. Various additional components could alternatively or additionally be employed by the powertrain 10 within the scope of this disclosure.

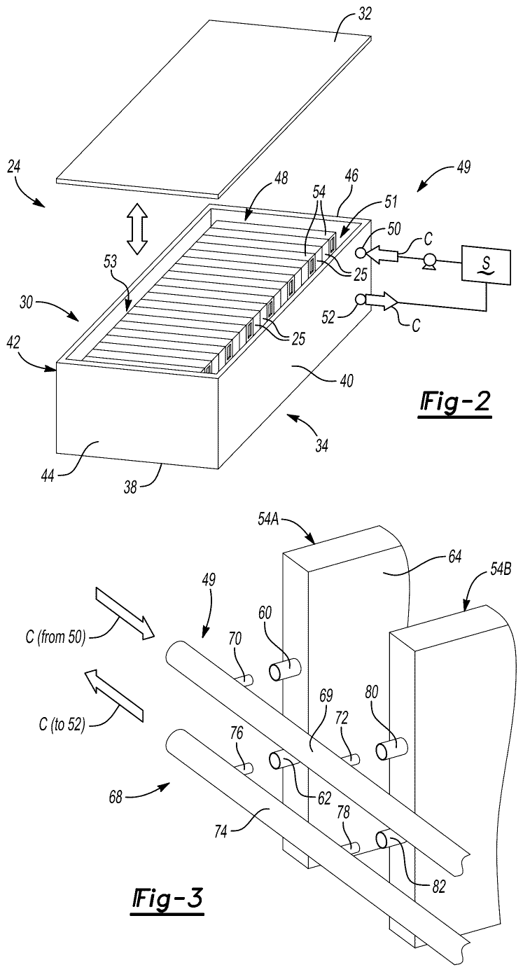

FIG. 2 illustrates additional detail of the example battery pack 24. In this example, the battery pack 24 includes an enclosure assembly 30. The enclosure assembly 30 includes a cover 32 and a tray 34. The cover 32, in this example, is vertically above the tray 34. In other examples, however, the cover 32 could be arranged below, or to a side of the tray 34. Various terms such as “above,” “below,” “top,” and “bottom” are used relative to the arrangement of the battery pack 24 in the various drawings and should not otherwise be deemed limiting.

The cover 32 is welded to the tray 34 in one example of this disclosure. While welding is mentioned, the cover 32 and tray 34 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

The cover 32 provides a top wall of the enclosure assembly 30. The tray 34 includes a bottom wall 38 opposite the cover 32, a first side wall 40, a second side wall 42 opposite the first side wall 40, a first end wall 44, and a second end wall 46 opposite the first end wall 44. The walls 38, 40, 42, 44, 46 of the tray 34 are configured to hold a battery array 48 (“array 48”).

The enclosure assembly 30 includes an inlet 50, which in this example is formed in the first side wall 40, and an outlet 52, which in this example is also formed in the first side wall 40. Various fluid couplings may be provided relative to the inlet 50 and outlet 52. Together, the fluid couplings establish a fluid channel 49, which is a series of pipes, conduits, and sections collectively forming a continuous path for fluid flow. The fluid channel 49 is coupled to a source S of fluid. The source S may be a reservoir. The fluid in this example is coolant C. The coolant C may be referred to as thermal exchange fluid. The fluid channel 49 may by in fluid communication with one or more pumps P configured to pressurize the coolant C.

The fluid channel 49 is configured to direct coolant C relative to the array 48 to thermally condition the array 48, such as by absorbing heat from the array 48. The coolant C may be referred to as thermal exchange fluid. In this example, the coolant C generally flows from the source S, to the inlet 50, within the enclosure assembly 30, back to the outlet 52, and ultimately back to the source S.

In this disclosure, the array 48 of battery cells 25 is arranged within the battery pack 24. The battery cells 25 are generally stacked face-to-face to construct the array 48. The battery pack 24 could employ any number of battery cells 25 within the scope of this disclosure. In FIG. 2, every two battery cells 25 are spaced-apart by a thermal exchange module 54. The thermal exchange modules 54 may be considered part of the array 48.

The thermal exchange modules 54 are configured as thermal exchange ribbons in this example. The thermal exchange modules 54 could be configured as tubes, channels, or fins, as other examples. While in FIG. 2 the thermal exchange modules 54 are between adjacent battery cells 25, the thermal exchange modules 54 could be configured as a thermal exchange plate, sometimes referred to as “cold plate,” and in that example may extend substantially an entire length of the array 48 and be arranged adjacent a bottom, top, or side of each of the battery cells 25.

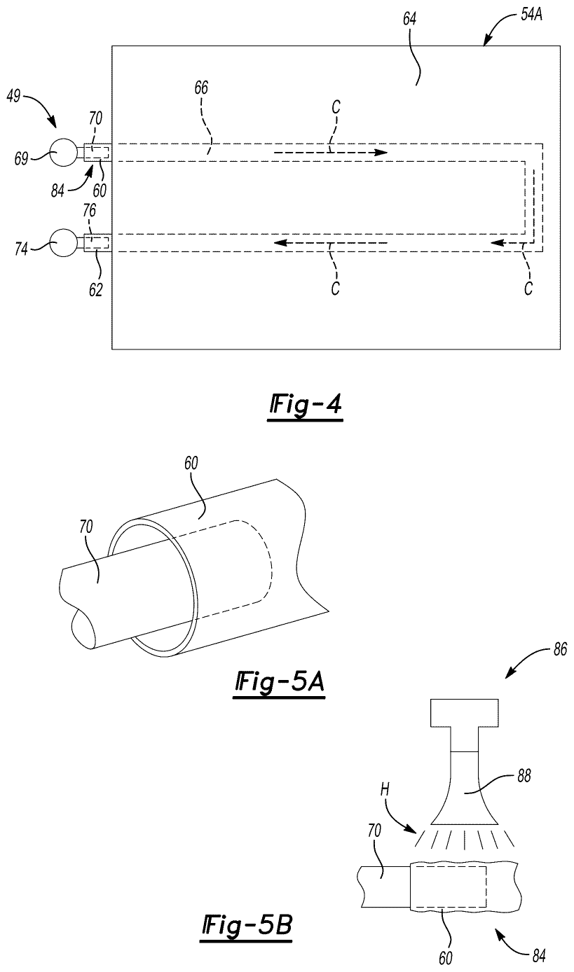

FIG. 3 illustrates two example thermal exchange modules 54A, 54B relative to a portion of the fluid channel 49. FIG. 4 further illustrates the thermal exchange module 54A relative to the fluid channel 49. With joint reference to FIGS. 3 and 4, the thermal exchange module 54A will now be described. The thermal exchange module 54B, and any other thermal exchange modules 54, may be arranged relative to the fluid channel 49 in substantially the same manner as thermal exchange module 54A.

The thermal exchange module 54A includes an inlet port 60, an outlet port 62, and a main body portion 64. In this example, the inlet and outlet ports 60, 62 are arranged on a side of the thermal exchange module 54A. The main body portion 64 is a majority of the thermal exchange module 54A by area. The main body portion 64 includes an internal passageway 66 (FIG. 4) fluidly coupling the inlet port 60 to the outlet port 62. The internal passageway 66 is a hollow channel within the main body portion 64 and may take on any routing within the main body portion 64, such as following a generally serpentine or tortuous path, as examples. The main body portion 64 may be formed by injection molding, additive manufacturing, or another known technique. In an embodiment, the main body portion 64 is formed by attaching two independently formed halves using a technique such as welding.

Coolant C is directed into the thermal exchange modules 54A, 54B via the fluid channel 49. In FIG. 3, a portion of the fluid channel 49 is configured as a manifold 68. The manifold 68 is arranged within the enclosure assembly 30 in this example. The manifold 68 includes a first section 69 fluidly coupled with the inlet 50 and configured to direct coolant C to the thermal exchange modules 54A, 54B via a first outlet port 70 and a second outlet port 72. The manifold 68 further includes a second section 74 configured to direct coolant C expelled from the thermal exchange modules 54A, 54B via a first inlet port 76 and a second inlet port 78 to outlet 52.

The first outlet port 70 is configured to fluidly couple to the inlet port 60 of the thermal exchange module 54A via a first interface, and the first inlet port 76 is configured to fluidly couple to the outlet port 62 of the thermal exchange module 54A via a second interface. The second outlet port 72 and second inlet port 78 are likewise configured to fluid couple to inlet and outlet ports 80, 82, respectively, of the thermal exchange module 54B via third and fourth interfaces. Similar interfaces are present between the manifold 68 and any other thermal exchange modules 54. While a manifold 68 is shown, a manifold is not required in all examples.

In this disclosure, interfaces between the thermal exchange modules 54 and the fluid channel 49 include a thermally shrinkable material. In particular, interfaces between inlets and outlets of the thermal exchange modules 54 and corresponding outlets and inlets of the manifold 68 include a thermally shrinkable material.

An example interface 84 between the inlet port 60 and the outlet port 70 is shown in FIGS. 4 and 5B. The example interface 84 is representative of other interfaces between the fluid channel 49 and the thermal exchange modules 54. As shown in FIGS. 4 and 5B, the outlet port 70 is arranged partially within inlet port 60. In this regard, the inlet and outlet ports 60, 70 can exhibit a common cross-sectional shape, such as a substantially circular cross-sectional shape, to facilitate alignment of the inlet and outlet ports 60, 70, as shown in FIG. 5A. This disclosure extends to other cross-sectional shapes for the various inlet and outlet ports. Further, while a portion of the outlet port 70 is within the inlet port 60 in this example, the arrangement could be reversed in other examples, with a portion of the inlet port 60 received within the outlet port 70.

In this example, the inlet port 60 includes a thermally shrinkable material, and in particular the inlet port 60 is at least partially made of thermally shrinkable material. In a specific example, the inlet port 60 is made entirely of a thermally shrinkable material. The main body portion 64 may be made of a different material than the inlet port 60. The main body portion 64, however, could be made of thermally shrinkable material in other examples. Specifically, the entire thermal exchange module 54 may be integrally as a single, integrated structure of thermally shrinkable material. The thermally shrinkable material is a polyolefin material in one example.

Application of heat to the inlet port 60 causes the inlet port 60 to shrink relative to an original dimension of the inlet port 60. Heat may be applied to the inlet port 60 via a heat applicator 86 (FIG. 5B). The heat applicator 86 may include an attachment 88 configured direct heat H to the inlet port 60, while avoiding directing heat to the main body portion 64. The outlet port 70, which is partially within the inlet port 60, is not made of thermally shrinkable material such that the outlet port 70 maintains its shape when heat H is applied to interface. When heat H is applied to the inlet port 60, the inlet port 60 reduces in size such that the inlet port 60 seals against the outer wall(s) of the outlet port 70. After the inlet port 60 shrinks, the thermally shrinkable material has no stored elastic energy left to drive it back to the original, expanded shape. Therefore, a fluid-tight connection is established. An adhesive may be applied between the inlet port 60 and the outlet port 70 before the application of heat H to further facilitate formation of the fluid-tight connection.

It should be understood that terms such as “about,” “substantially,” and “generally” are not intended to be boundaryless terms, and should be interpreted consistent with the way one skilled in the art would interpret those terms. It should also be understood that directional terms such as “upper,” “top,” “vertical,” “forward,” “rear,” “side,” “above,” “below,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A system for a motor vehicle, comprising:
a thermal exchange module configured to transfer heat between a component of the motor vehicle and a fluid, wherein the thermal exchange module is fluidly coupled to a fluid channel via an interface including a thermally shrinkable material.

2. The system as recited in claim 1, wherein:
the interface includes a first port and a second port at least partially within the first port, and
the first port is made of a thermally shrinkable material.

3. The system as recited in claim 2, wherein the fluid channel includes the second port and the thermal exchange module includes the first port.

4. The system as recited in claim 2, wherein the fluid channel includes the first port and the thermal exchange module includes the second port.

5. The system as recited in claim 1, wherein:
the thermal exchange module includes an inlet port, an outlet port, and a main body portion, and
the main body portion includes an internal passageway fluidly coupling the inlet port to the outlet port.

6. The system as recited in claim 5, wherein an entirety of the thermal exchange module is made of thermally shrinkable material.

7. The system as recited in claim 5, wherein the inlet and outlet ports include thermally shrinkable material, and the main body portion is made of a material other than thermally shrinkable material.

8. The system as recited in claim 5, wherein:
the inlet port is configured to receive a flow of the fluid a via the inlet port,
the inlet port is fluidly coupled to the fluid channel via a first interface including a thermally shrinkable material,
the outlet port is configured to expel a flow of the fluid to the fluid channel, and
the outlet port is fluidly coupled to the fluid channel via a second interface including a thermally shrinkable material.

9. The system as recited in claim 1, wherein:
the thermal exchange module is a first thermal exchange module of a plurality of thermal exchange modules of the system,
the fluid channel includes a manifold configured to distribute fluid relative to each of the plurality of thermal exchange modules, and
interfaces between each of the thermal exchange modules and the manifold include a thermally shrinkable material.

10. The system as recited in claim 1, wherein the thermally shrinkable material is a polyolefin material.

11. The system as recited in claim 10, wherein an entirety of the thermal exchange module is made of polyolefin.

12. The system as recited in claim 1, wherein:
the motor vehicle is an electrified vehicle, and
the thermal exchange module is arranged between battery cells within a battery array of the electrified vehicle.

13. The system as recited in claim 1, wherein the thermal exchange module is one of a tube, fin, or channel.

14. The system as recited in claim 1, wherein the component of the motor vehicle is a battery pack.

15. The system as recited in claim 1, wherein the interface includes an adhesive.

16. A method, comprising:
establishing a fluid-tight connection between a fluid channel and a thermal exchange module of a motor vehicle by applying heat to an interface of the fluid channel and the thermal exchange module, wherein the interface includes a thermally shrinkable material.

17. The method as recited in claim 16, wherein:
the interface includes a first port and a second port at least partially within the first port, and
the first port is made of a thermally shrinkable material.

18. The method as recited in claim 17, wherein the fluid channel includes one of the first port or the second port, and the thermal exchange module includes the other of the first port or the second port.

19. The method as recited in claim 16, wherein:
the thermal exchange module includes an inlet port, an outlet port, and a main body portion,
the main body portion includes an internal passageway fluidly coupling the inlet port to the outlet port, and
the method includes establishing a fluid-tight connection between the fluid channel and the inlet port by applying heat to a thermally shrinkable material, and further includes establishing a fluid-tight connection between the fluid channel and the outlet port by applying heat to a thermally shrinkable material.

20. The method as recited in claim 16, wherein:
the thermal exchange module is a first thermal exchange module of a plurality of thermal exchange modules,
the fluid channel includes a manifold configured to distribute fluid relative to each of the plurality of thermal exchange modules,
the method includes establishing fluid-tight connections between the manifold and each of the thermal exchange modules by applying heat to interfaces between each of the thermal exchange modules and the manifold, and
each of the interfaces includes a thermally shrinkable material.
